(19) United States
(12) Patent Application Publication
(10) Pub. No.: US 2014/0318857 A1
(43) Pub. Date: Oct. 30, 2014

(54) METHOD FOR FABRICATING A CONDUCTIVE YARN AND CONDUCTIVE YARN FABRICATED BY THE METHOD

(71) Applicant: Asiatic Fiber Corporation, Taipei City (TW)

(72) Inventors: Wen-Hsien Sun, Pingzhen City (TW); Yao-Yuan Chang, Douliu City (TW); Zhi-Long Chen, Zhudong Township (TW)

(73) Assignee: Asiatic Fiber Corporation, Taipei City (TW)

(21) Appl. No.: 14/261,074

(22) Filed: Apr. 24, 2014

(30) Foreign Application Priority Data
Apr. 26, 2013 (TW) 102115098

(51) Int. Cl. H01B 5/00; D06B 15/00; D06M 11/00; D06B 3/04

(52) U.S. Cl. CPC H01B 5/002; D06B 3/04; D06B 15/005; D06M 11/00
USPC 174/70 R; 19/27; 19/66 R

(57) ABSTRACT

A method for fabricating a conductive yarn includes the steps of: moistening a preformed yarn with a conductive slurry to prepare the preformed yarn absorbed with the conductive slurry; and drying the preformed yarn absorbed with the conductive slurry. The conductive slurry includes a conductive nanometer structure, a solvent, and a resin component. The conductive nanometer structure has an aspect ratio sufficient to permit binding of the conductive nanometer structure to the preformed yarn.

### CROSS-REFERENCE TO RELATED APPLICATION

This application claims priority of Taiwanese Application No. 102115098, filed on Apr. 26, 2013.

### BACKGROUND OF THE INVENTION

1. Field of the Invention

The invention relates to a method for fabricating a yarn, more particularly to a method for fabricating a conductive yarn. The invention also relates to a conductive yarn fabricated by the method.

2. Description of the Related Art

Conductive fibers are widely utilized in anti-static, dustproof, or explosion-proof clothing used in the fields of semiconductor, electronic, medical engineering, bioengineering industries and the like. The conductive fibers may also be used in materials for shielding or absorbing electromagnetic wave, heat-generating components of electrothermal products, and glove structures for operating a capacitive touch panel. Compared to conventional textile materials, the conductive fibers are hi-technology products in the textile industries. There are various known methods for producing the conductive fibers, such as metal fiber coating, surface treating, melt spinning, and the like.

For example, Taiwanese patent publication No. m422556 discloses a technique in which conductive metal is vapor-deposited on a substrate such as a paper material or a synthetic resin film. The substrate vapor-deposited with the conductive metal is subsequently cut, followed by twisting so as to produce yarn threads.

Additionally, plasma chemical deposition has been used to coat metal on nylon fibers so as to produce conductive fibers. However, the equipment for performing the plasma chemical deposition is expensive, and the process for the plasma chemical deposition is time-consuming.

Both of the vapor deposition and the plasma chemical deposition are power-consuming and time-consuming, and are expensive to implement.

Taiwanese patent publication No. 200940780 discloses a manufacturing method of nano silver oxidization fiber products and nano silver carbon fiber products. The manufacturing method comprises the steps of: (a) placing oxidization fibers or carbon fibers in a silver salt solution; (b) placing the oxidization fibers or carbon fibers after step (a) into a reducing agent in order to reduce silver ions to silver and to adhere silver to the oxidization fibers or carbon fibers; (c) washing the oxidization fibers or carbon fibers after step (b) using deonized water; and (d) drying the oxidization fibers or carbon fibers after step (c) to obtain the nano silver oxidization fiber products or the nano silver carbon fiber products.

The aforesaid method involves reducing metal ions to metal particles for adhering to the fibers. However, the solubility of the metal salt is usually not sufficiently high, and the precipitation rate and the homogeneity of the metal particles may not be controlled easily. Therefore, the electric conduction property of the nano silver oxidization fiber products or the nano silver carbon fiber products manufactured by the aforesaid method may not be good or uniform.

### SUMMARY OF THE INVENTION

The object of the present invention is to provide a method for fabricating a conductive yarn, which has high process efficiency, which is relatively low cost, and which may produce a conductive yarn with good conductivity.

According to a first aspect of this invention, there is provided a method for fabricating a conductive yarn. The method includes the steps of:

(A) moistening a preformed yarn with a conductive slurry to prepare the preformed yarn absorbed with the conductive slurry; and

(B) drying the preformed yarn absorbed with the conductive slurry.

The conductive slurry includes a conductive nanometer structure, a solvent, and a resin component, and the conductive nanometer structure has an aspect ratio sufficient to permit binding of the conductive nanometer structure to the preformed yarn.

According to a second aspect of this invention, there is provided a conductive yarn which includes a preformed yarn, a conductive nanometer structure, and a resin component that binds the conductive nanometer structure to the preformed yarn. The conductive nanometer structure has an aspect ratio sufficient to permit binding of the conductive nanometer structure to the preformed yarn.

An advantage of the present invention is that the preformed yarn may absorb a significant amount of the conductive slurry homogeneously and that the conductive nanometer structure binds to the preformed yarn to manufacture the conductive yarn having good conductivity by drying (for example, baking) the preformed yarn absorbed with the conductive slurry. The method for fabricating a conductive yarn according to this invention has reduced process period and production cost as compared to the aforesaid prior art.

### BRIEF DESCRIPTION OF THE DRAWINGS

Other features and advantages of the present invention will become apparent in the following detailed description of the preferred embodiments with reference to the accompanying drawings, of which:

FIG. 1 is a flow chart illustrating a preferred embodiment of a method for fabricating a conductive yarn according to this invention;

FIG. 2 is a schematic view illustrating the operating procedure of the preferred embodiment; and

FIG. 3 is a diagram illustrating a relationship between an aspect ratio of a conductive nanometer structure and surface resistance.

### DETAILED DESCRIPTION OF THE PREFERRED EMBODIMENTS

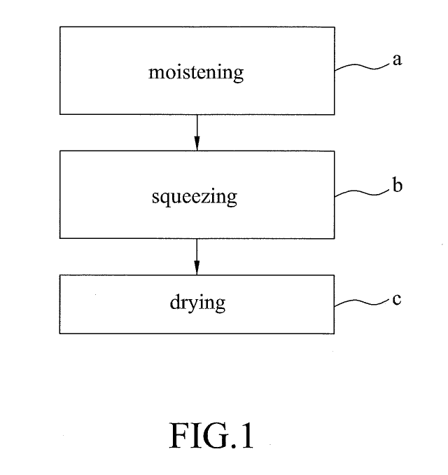

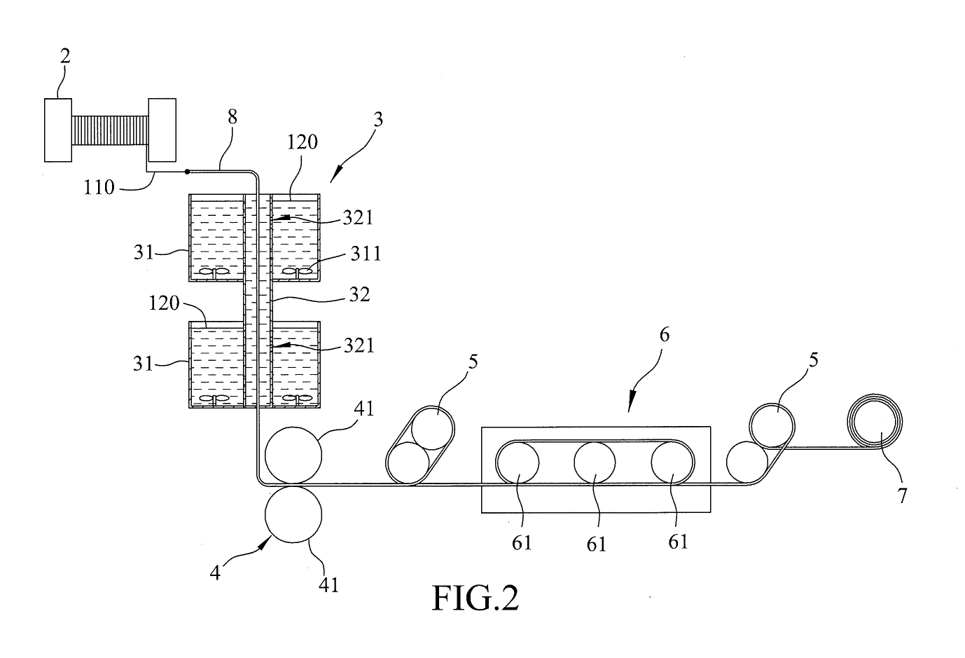

Referring to FIGS. 1 and 2, a preferred embodiment of a method for fabricating a conductive yarn according to this invention includes the steps of:

### (a) Moistening:

A preformed yarn is moistened with a conductive slurry to prepare the preformed yarn absorbed with the conductive slurry. Preferably, the preformed yarn is soaked in the conductive slurry for about one minute. Specifically, as shown in FIG. 2, the preformed yarn is passed through the conductive slurry continuously.

The conductive slurry includes a conductive nanometer structure, a solvent, and a resin component. The conductive nanometer structure has an aspect ratio sufficient to permit binding of the conductive nanometer structure to the preformed yarn. Specifically, the conductive slurry is made by dispersing the conductive nanometer structure in a dispersant formed of the solvent and the resin component. Preferably, the conductive slurry further includes a thickening agent and a defoaming agent. In the conductive slurry useful in this invention, the conductive nanometer structure is a conductive nano wire made from a material, such as silver, copper, or carbon nanotube. The solvent is water, and the resin is an aqueous resin, such as polyurethane resin, acrylic resin, and the combination thereof. Examples of the thickening agent include inorganic salts, celluloses, esters, and combinations thereof. Examples of the defoaming agent include aqueous organosilicons, aqueous mineral oils, ethoxylated polyoxypropylene, and combinations thereof. Preferably, the conductive nanometer structure is in an amount ranging from 1 wt % to 5 wt %, the solvent is in an amount ranging from 45 wt to 55 wt %, the resin component is in an amount ranging from 45% to 55 wt %, the thickening agent is in an amount less than 2 wt %, and the defoaming agent is in an amount not more than 0.02 wt % based on 100 wt % of the conductive slurry.

The term “aspect ratio” of a conductive nanometer structure, as used in the specification, refers to a ratio of its length to a diameter of its cross section. When the aspect ratio of the conductive nanometer structure is too small (that is, the conductive nanometer structure is sphere-like), the conductive nanometer structure is liable to agglomerate, and the absorption effect of the conductive nanometer structure with respect to the preformed yarn is inferior. On the other hand, when the aspect ratio of the conductive nanometer structure is too large, the conductive nanometer structure may not be dispersed homogeneously in the dispersant formed of the solvent and the resin component, and the homogeneity of the conductive nanometer structure absorbed on the preformed yarn may be negatively affected. Preferably, the conductive nanometer structure used in this invention is a conductive nano wire made of silver and having an aspect ratio ranging from 200 to 250.

### (b) Squeezing:

The preformed yarn absorbed with the conductive slurry is then squeezed so as to remove an excess amount of the conductive slurry.

### (c) Drying:

The preformed yarn absorbed with the conductive slurry is dried (for example, by baking) at a temperature ranging from 120° C. to 150° C. for a period ranging from 10 mins to 15 mins. The resin component is cured in the drying step so as to bind the conductive nanometer structure to the preformed yarn via the cured resin component.

FIG. 2 illustrates an apparatus for performing the preferred embodiment of a method for fabricating a conductive yarn according to this invention. The apparatus includes a yarn spool 2, a soaking unit 3, a squeezing unit 4, two roller assemblies 5, a heating roller unit 6, and a yarn winder 7.

The conductive slurry 120 is received in two soaking tanks 31 of the soaking unit 3. The soaking tanks 31 are respectively installed with a stirring member 311, and are connected to each other via a connecting tube 32. The stirring member 311 is used for dispersing the conductive nanometer structure homogeneously in the dispersant formed of the solvent and the resin component and for absorbing the conductive nanometer structure on the preformed yarn 110 evenly. The connecting tube 32 is used for permitting the preformed yarn 110 to pass therethrough and is formed with a plurality of perforations 321 for introducing the conductive slurry 120 into the connecting tube 32.

The squeezing unit 4 is constituted by two rollers 41 abutting against each other. The heating roller unit may be controlled at a predetermined heating temperature. One of the roller assemblies 5 is disposed between the squeezing unit 4 and the heating roller unit 6, while the other of the roller assemblies 5 is disposed between the heating roller unit 6 and the yarn winder 7.

The preformed yarn 110 is wound on the yarn spool 2 and one end of the preformed yarn 110 is connected to one end of a leading wire 8. The other end of the leading wire 8 is connected to the yarn winder 7. When the yarn winder 7 is activated, the leading wire 8 is pulled by the yarn winder 7, and the preformed yarn 110 is subjected to the aforesaid moistening step (a) when moving toward the yarn winder 7. Specifically, the preformed yarn 110 enters into and passes through the connecting tube 32 and is moistened by the conductive slurry 120 in the soaking tanks 31.

After leaving the soaking unit 3, the preformed yarn 110 passes through the squeezing unit 4 and is subjected to the aforesaid squeezing step (b). Specifically, the preformed yarn 110 absorbed with the conductive slurry 120 passes through the rollers 41 of the squeezing unit 4 to remove an excess amount of the conductive slurry 120 from the preformed yarn 110.

After passing through the squeezing unit 4, the preformed yarn 110 is transported into the heating roller unit 6 and is subjected to the aforesaid drying step (c). Specifically, the heating roller unit 6 is composed of a plurality of heating rollers 61. When the preformed yarn 110 absorbed with the conductive slurry 120 is transported through and heated by the heating rollers 61, the resin component contained in the conductive slurry 120 is cured so as to bind the conductive nanometer structure to the preformed yarn 110 via the cured resin component and to obtain the conductive yarn. The conductive yarn thus obtained is then wound on the yarn winder 7.

The conductive yarn fabricated according to the method of this invention includes a preformed yarn, a conductive nanometer structure, and a resin component that binds the conductive nanometer structure to the preformed yarn. The conductive nanometer structure has an aspect ratio sufficient to permit binding of the conductive nanometer structure to the preformed yarn.

As described above, the conductive nanometer structure is preferably a conductive nano wire made from silver, copper, or carbon nanotube, and more preferably a conductive nano wire made of silver, and has the aspect ratio ranging from 200 to 250. The resin component is polyurethane resin, acrylic resin, or the combination thereof. The preformed yarn is polyethylene terephthalate, polyamide, polypropylene, polyacrylic, or combinations thereof.

As compared to the aforesaid conventional plasma chemical deposition method, the method for fabricating a conductive yarn according to this invention uses a relatively simple apparatus, and has a relatively low production cost and a relatively short process period. As compared to the aforesaid reduction method, the conductive nanometer structure having a specific aspect ratio is used in the conductive slurry so that the conductive yarn thus obtained has improved conductivity.

### EXAMPLES

The following examples are provided to illustrate the preferred embodiments of the invention, and should not be construed as limiting the scope of the invention.

### Example 1

The conductive slurry used in this example is composed of an aqueous resin (a polyurethane resin) in an amount of 44.5 wt %, a thickening agent in an amount of 0.5 wt %, a defoaming agent in an amount of 0.02 wt %, a conductive nano wire made of silver in an amount of 5 wt %, and a solvent (water) in a balance amount based on 100 wt % of the conductive slurry. The aforesaid preferred embodiment of the method for fabricating a conductive yarn according to this invention was performed to obtain a conductive yarn. The conductive nano wires having different aspect ratios were used in

### Examples 1-1 to 1-6

The surface resistance of each of the conductive yarns obtained in Examples 1-1 to 1-6 was measured at 10 cm and 100 cm using a multi-meter. The conductivity of each of the conductive yarns obtained in Examples 1-1 to 1-6 was determined by the luminescence of an LED light source connected to the conductive yarns. The result is shown in Table 1.

TABLE 1

| | | Examples | | | | |
|---|---|---|---|---|---|---|
| | | 1-1 | 1-2 | 1-3 | 1-4 | 1-5 |
| Aspect ratio | | 1 | 10 | 200 | 225 | 250 |
| Conductivity | | X | X | ◯ | ◯ | ◯ |
| Surface | 10 cm | <10¹³ | <10¹³ | <10² | <10² | <10² |
| Resistance | 100 cm | <10¹⁴ | <10¹⁴ | <10³ | <10³ | <10³ |
| (Ω/sqr) | | | | | | |

As shown in Table 1, the aspect ratio of the conductive nano wire is preferably larger than 200. When the aspect ratio of the conductive nano wire is too small (that is, the conductive nano wire is sphere-like), the conductive nano wire may not be absorbed effectively and sufficiently on the preformed yarn using a conductive slurry having a low amount of the conductive nano wire.

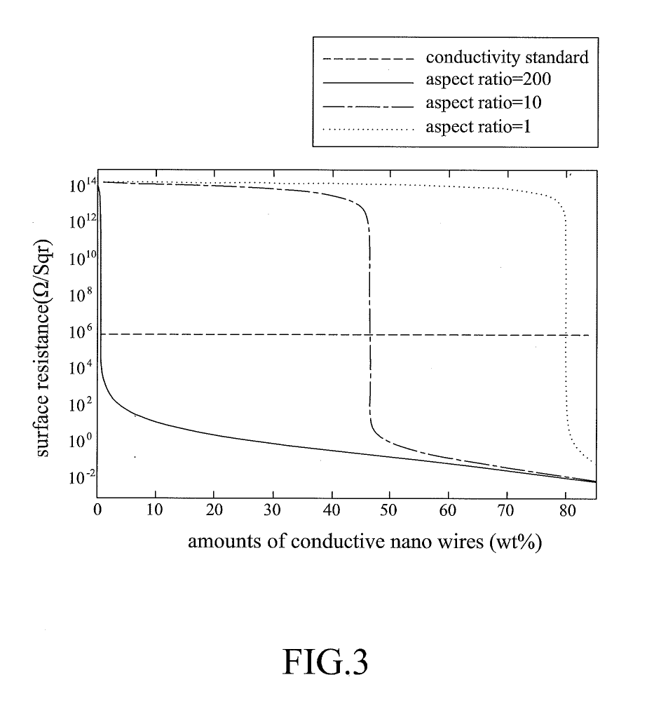

FIG. 3 shows test result of the surface resistances of the conductive yarns at 100 cm. It can be found from the test result that the aspect ratio is a critical factor for the conductivity of the conductive yarn. When the conductive nano wire having an aspect ratio of 1 is used in the conductive slurry, a conductive slurry containing the conductive nano wire in an amount higher than 80 wt % is required for achieving the required standard of the luminescence of an LED light source. When the absorption of the conductive nano wire on the preformed yarn has achieved a homogeneous state, the conductivity of the conductive yarn may not be significantly enhanced by further increasing the amount of the conductive nano wire in the conductive slurry. However, the dispersion of the conductive nano wire in the conductive slurry may be affected negatively, which may affect the absorption of the conductive nano wire on the preformed yarn. Additionally, the conductive nano wire having high aspect ratio may be produced with higher difficultly, and the production cost thereof may be increased. Therefore, the aspect ratio of the conductive nano wire ranges preferably from 200 to 250.

### Example 2

The conductive slurry used in this example is composed of an aqueous resin (a polyurethane resin) in an amount of 44.5 wt %, a thickening agent in an amount of 0.5 wt %, a defoaming agent in an amount of 0.02 wt %, a conductive nano wire made of silver in an amount ranging from 0.1 wt % to 10 wt %, and a solvent (water) in a balance amount based on 100 wt % of the conductive slurry. The aspect ratio of the conductive nano wire is 200. The aforesaid preferred embodiment of the method for fabricating a conductive yarn according to this invention was performed to obtain a conductive yarn. The amounts of the conductive nano wires in the conductive slurries used in Examples 2-1 to 2-6 are 0.1 wt %, 0.5 wt %, 1 wt %, 3 wt %, 5 wt %, and 10 wt %, respectively. The result is shown in Table 2.

TABLE 2

| | Examples | | | | | |
|---|---|---|---|---|---|---|
| | 2-1 | 2-2 | 2-3 | 2-4 | 2-5 | 2-6 |
| Amounts of | 0.1 | 0.5 | 1 | 3 | 5 | 10 |
| conductive | | | | | | |
| nano wire (wt %) | | | | | | |
| Conductivity | X | Δ | ◯ | ◯ | ◯ | ◯ |
| Surface | 10⁷-10⁸ | 10⁵-10⁶ | <10⁴ | <10⁴ | <10³ | <10³ |
| resistance at | | | | | | |
| 100 cm(Ω) | | | | | | |

As shown in Table 2, when the conductive nano wire having an aspect ratio of 200 is used in the conductive slurry, the amount of the conductive nano wire in the conductive slurry is preferably from 1 wt % to 5 wt %. Specifically, when the amount of the conductive nano wire in the conductive slurry is too low, the absorption of the conductive nano wire on the preformed yarn may be insufficient, and the conductive yarn thus produced may not have satisfactory conductivity. Referring to FIG. 3, when the amount of the conductive nano wire in the conductive slurry is higher than a critical amount, the surface resistance of the conductive yarn does not vary significantly.

In view of the aforesaid, in the method for fabricating a conductive yarn according to this invention, a conductive slurry including a conductive nanometer structure having a specific aspect ratio is used, and the resin component contained in the conductive slurry is cured by drying (for example, baking) so that the conductive nanometer structure may bind to the preformed yarn via the cured resin component. A conductive yarn having good conductivity may be produced accordingly.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for fabricating a conductive yarn, comprising the steps of:
(A) moistening a preformed yarn with a conductive slurry to prepare the preformed yarn absorbed with the conductive slurry; and
(B) drying the preformed yarn absorbed with the conductive slurry,
wherein the conductive slurry includes a conductive nanometer structure, a solvent, and a resin component, the conductive nanometer structure having an aspect ratio sufficient to permit binding of the conductive nanometer structure to the preformed yarn.

2. The method according to claim 1, wherein the conductive nanometer structure includes a conductive nano wire.

3. The method according to claim 2, wherein the conductive nano wire is made from a material selected from the group consisting of silver, copper, and carbon nanotube.

4. The method according to claim 3, wherein the conductive nano wire is made of silver, and has the aspect ratio ranging from 200 to 250.

5. The method according to claim 1, wherein the conductive slurry further includes a thickening agent and a defoaming agent, the conductive nanometer structure being in an amount ranging from 1 wt % to 5 wt %, the solvent being in an amount ranging from 45 wt to 55 wt %, the resin component being in an amount ranging from 45% to 55 wt %, the thickening agent being in an amount less than 2 wt %, and the defoaming agent being in an amount not more than 0.02 wt % based on 100 wt % of the conductive slurry.

6. The method according to claim 1, wherein the solvent is water, and the resin is an aqueous resin selected from the group consisting of polyurethane resin, acrylic resin, and the combination thereof.

7. The method according to claim 1, further comprising a step of squeezing the preformed yarn absorbed with the conductive slurry prior to step (B).

8. The method according to claim 1, wherein step (B) is conducted at a temperature ranging from 120° C. to 150° C.

9. The method according to claim 1, wherein the conductive slurry is made by dispersing the conductive nanometer structure in a dispersant formed of the solvent and the resin component.

10. The method according to claim 1, wherein step (a) is conducted by soaking the preformed yarn in the conductive slurry for about one minute.

11. The method according to claim 1, wherein the resin component is cured in step (b) so as to bind the conductive nanometer structure to the preformed yarn via the cured resin component.

12. A conductive yarn comprising:
a preformed yarn;
a conductive nanometer structure; and
a resin component that binds said conductive nanometer structure to said preformed yarn,
wherein said conductive nanometer structure has an aspect ratio sufficient to permit binding of said conductive nanometer structure to said preformed yarn.

13. The conductive yarn according to claim 12, wherein said conductive nanometer structure includes a conductive nano wire.

14. The conductive yarn according to claim 13, wherein said conductive nano wire is made from a material selected from the group consisting of silver, copper, and carbon nanotube.

15. The conductive yarn according to claim 14, wherein said conductive nano wire is made of silver, and has the aspect ratio ranging from 200 to 250.

16. The conductive yarn according to claim 12, wherein said resin component is selected from the group consisting of polyurethane resin, acrylic resin, and the combination thereof.

17. The conductive yarn according to claim 12, wherein said preformed yarn is selected from the group consisting of polyethylene terephthalate, polyamide, polypropylene, polyacrylic, and combinations thereof.
